(19) United States
(12) Patent Application Publication
(10) Pub. No.: US 2023/0410429 A1
(43) Pub. Date: Dec. 21, 2023

(54) EFFICIENT METHOD FOR THREE-DIMENSIONAL IMAGE RECONSTRUCTION OF REMOTE AND INVISIBLE TARGETS FROM PHYSICAL SENSORS BASED ON DEEP LEARNING ARTIFICIAL INTELLIGENCE

(71) Applicant: SOUVIK MUKHERJEE, Katy, TX (US)

(72) Inventor: SOUVIK MUKHERJEE, Katy, TX (US)

(21) Appl. No.: 18/106,334

(22) Filed: Feb. 6, 2023

Related U.S. Application Data
(60) Provisional application No. 63/310,106, filed on Feb. 15, 2022.

(51) Int. Cl. G06T 17/20

(52) U.S. Cl. CPC G06T 17/205

(57) ABSTRACT

A method and system for three-dimensional reconstruction of material properties of a target using remotely located physical sensors is disclosed. The special technique disclosed here, enables an order of magnitude improvement in computational speed and memory requirements over current state-of-the-art artificial intelligence-based systems. When compared against state-of-the-art methods that do not use artificial intelligence, the improvement in accuracy and resolution enables deployment of order of magnitude cheaper data acquisition systems and/or provide the practical capability to image targets previously considered out-of-bounds. The use cases include but are not limited to oil field application systems such as the monitoring of pipeline health and integrity, leak, and spill extent delineation, seismic imaging systems, and for applications in agriculture, medical imaging, unexploded ordnance detection, mining, wind energy foundation studies, geotechnical work, groundwater systems, environmental science and engineering, and other problems where remote sensing-based image reconstruction is utilized/needed.

### FIELD OF THE INVENTION

This invention relates to a method and system for the three-dimensional reconstruction of material properties of a target using remotely located physical sensors. The sensors can illuminate the target using an active transmitter source such as one of acoustic, electromagnetic, or some other origin, while recording the response from the target in receivers placed in suitable locations. Alternatively, the receivers can record the target response in the presence of a passive source such as gravitational attraction and its gradients, the geomagnetic field, the magneto telluric field and others. Utilizing the special technique disclosed here, the method can provide an order of magnitude improvement in computational speed and memory requirements over current state-of-the-art artificial intelligence-based systems. When compared against state-of-the-art methods that do not rely on artificial intelligence, the current method can provide improvement in accuracy and resolution that can enable the deployment of order of magnitude cheaper data acquisition systems and/or provide the practical capability to image targets previously considered out-of-bounds using state-of-the art methods. The use cases include but are not limited to oil field application systems such as the monitoring of pipeline health and integrity, seismic imaging systems, and for applications in agriculture, medical imaging, unexploded ordnance detection, mining, and other problems where remote sensing-based image reconstruction is utilized/needed.

### BACKGROUND OF THE INVENTION

Three-dimensional image reconstruction using remote sensing sensors is a ubiquitous practice that cuts across many applications and industries ranging from the medical, oil and gas, mining, military, civil and environmental engineering, among others. The method uses physics-based algorithms to simulate the response of the target and its surroundings in the presence of an inducing field of electromagnetic, gravitational, seismic, ultrasonic, or some other origin and uses data optimization algorithms to find the material properties that can simulate a response that matches the recorded response by the receivers most closely.

The number of receivers recording the response is usually far fewer than the number of elements required to successfully simulate the observed response, leading to an underdetermined system with a non-unique (more than one) material property distribution that could potentially simulate the response observed by the sensors. This requires the imposition of certain a priori constraints on the nature of distribution of the material properties that are used to “match” the observed sensor response. In many geologic situations of increasing commercial interest, such constraints often lead to poorly reconstructed images which may not represent the subsurface at reliable levels of accuracy and/or resolution.

A key benefit of introduction of machine learning approaches to such efforts is the removal of explicit mathematical constraints on the distribution of the target material properties. Machine learning methods aim to “train” the system to “learn” the response of various material property realizations of the subsurface and then determine the “best” distribution of material property given the input of the observed sensor response. It has been observed that where the deployment of machine learning algorithms is technically, logistically, and commercially feasible, there is a step change improvement in the resolution and accuracy of the reconstructed image/material properties.

The major bottlenecks to such methods are twofold: 1) the large volume of simulations that need to be generated to accurately represent a “universe” of potential candidates that may represent the subsurface material property distribution. 2) The large memory consumption of the simulated models when being called for “training” by the machine learning algorithm. This effectively prevents the usage of machine learning algorithms for many problems of practical interest.

### SUMMARY OF THE INVENTION

Most state-of-the-art deep learning machine learning architectures used to address image reconstruction issues follow the blueprint of dividing the image domain into several small pixels which are mathematically represented as two- or three-dimensional matrices. The input data is also cast into a matrix whose format is similar to the target image domain. A series of machine learning layers are introduced between the input data and the target or output image. Each of these layers comprise a set of smaller matrices which are then mathematically combined with a set of weights that help transform the values of the input data matrix to the output image matrix.

The two- and three-dimensional nature of the input and output matrix combined with the similar dimensions of the smaller matrices in the intermediate layers make this process memory intensive and is a key barrier for the solution of very large-scale imaging problems in a commercially effective manner. The conventional method of image reconstruction that does not deploy machine learning methods, frequently stores this matrix as a one-dimensional vector and can map the input data to the dimensions of the output image by utilizing an adjoint operator. Given this transformation occurs at an intermediate step of a process that does not utilize artificial intelligence, the concept of utilizing the data post adjoint transformation as the initial input for machine learning is novel and not practiced anywhere. By making this change, the computational footprint of the image reconstruction problem is dramatically reduced by one or two major dimensions which then translates into order of magnitude savings in computation time and cost without compromising the accuracy and resolution gains made with machine learning methods.

Additionally, the method provides an easy method for designing machine learning algorithms for unstructured meshes, where the description of the images into clear cut divisions of U-, V-, and W-pixel units along each of the coordinate axes, x-, y-, and z- are not possible.

### BRIEF DESCRIPTION OF THE DRAWINGS AND FIGURES

FIG. 1. Schematic representation of image reconstruction or inversion method from geophysical sensor data. The sensors depicted by 1 are located on or above the ground surface. The subsurface is divided into regularly shaped rectangular cells depicted by 3 and 2. The cells depicted by 3 contain material property values of the background while those depicted by 2 contains the material property values of the anomalous target of interest.

FIG. 2. A schematic representation of a conventional deep machine learning architecture for reconstructing 2-D and 3-D images and/or material property inversion using remote sensors.

FIG. 3. A schematic representation of deep machine learning architecture for reconstructing 3-D images and/or material property inversion using remote sensors using 1-D vector basis functions only.

FIG. 4. Schematic representation of image reconstruction or inversion method from geophysical sensor data on an unstructured mesh. The sensors depicted by 15 are located on or above the ground surface. The subsurface is divided into arbitrarily shaped tetrahedral cells depicted by 16 and 17. The cells depicted by 16 contain material property values of the background while those depicted by 17 contains the material property values of the anomalous target of interest.

### DETAILED DESCRIPTION OF THE INVENTION

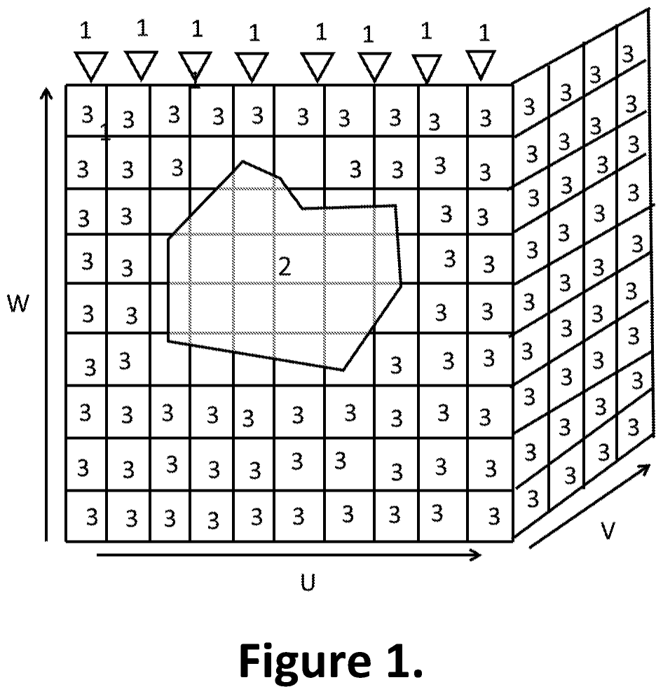

FIG. 1 shows the general scheme for imaging subsurface geologic and cultural targets using structured mesh. The receivers depicted by the triangular symbols (1) are placed on the surface of the earth while the subsurface is divided into rectangular cells. There are U and V cells in the horizontal directions X- and Y- of the cartesian coordinate system while the vertical Z-direction has W cells. The total number of cells are M=U× V× W. The anomalous target has material property distributed in the cells numbered 2 while the background property is distributed in the other cells numbered 3.

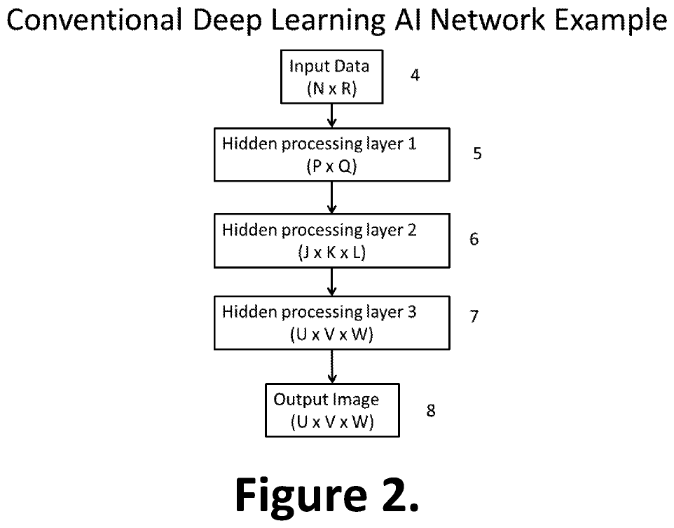

Referring to FIG. 2, a simple generic training architecture for current state-of-the-art deep multi-layer machine learning algorithm is shown for illustrative purposes. The input data, fed in the form of an N×R matrix, where N>1 and R≥1, present in the first layer depicted as 4, is processed by a set of mathematical operators present in the first hidden layer, depicted as 5, and its output matrix whose shape is P× Q sent to the second hidden layer, depicted as 6, wherein the shape of the output matrix is transformed to J× K× L. Eventually, these transformations will result in an output matrix whose dimensions will be the same as the desired output image (U× V× W). Based on the differences between the pixel values of the output matrix and those images used as ground truth for training, the system will continue to iterate until the difference between the pixel values of the predicted image and the ground truth are below a certain predetermined threshold and/or subsequent iterations do not alter this difference much.

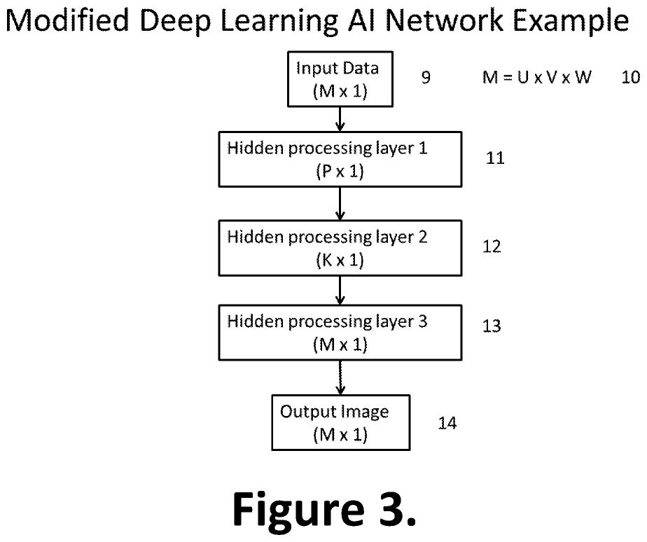

In FIG. 3, the modification to this approach is discussed. The adjoint operator can be used to reproject the input data 9 to the same dimensions as the output image matrix 14 and recast as a vector, 10. Now, all the processing steps (11-14) are simplified as vector operations instead of matrices which reduce the overall computational footprint by about an order of magnitude.

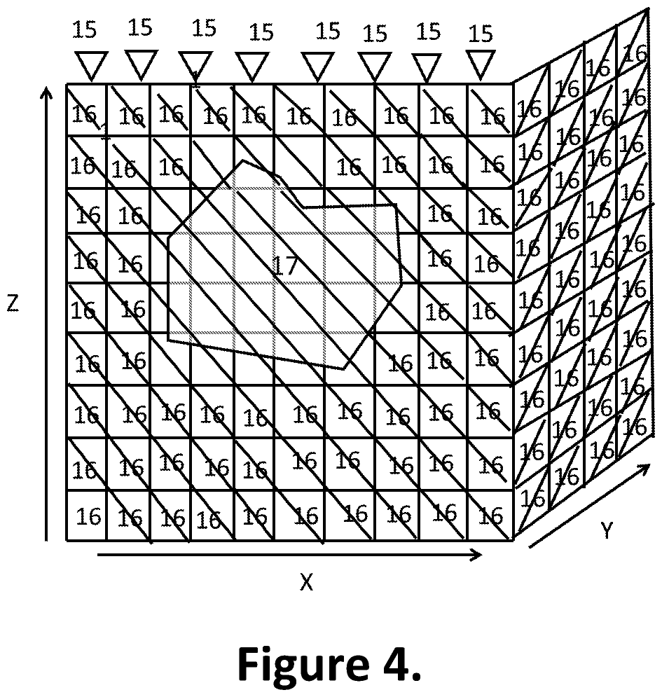

In addition, as shown in FIG. 4, it is now possible to support an arbitrary number of tetrahedral cells which are more flexible and do not require a fixed number of cells in the cartesian coordinate axes. This kind of imaging is not known to be currently performed using common machine learning architectures of the kind discussed here.

While the present invention has been described in terms of particular embodiments and applications, in both summarized and detailed forms, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the spirit of this invention.

Following claims are made in this application:

1) A novel physics-based formulation of the input data from remote sensing imaging sensors that enable the deployment of one-dimensional vector based deep machine learning architectures for multidimensional image reconstruction tasks and solving of inverse problems.

2) While the adjoint based formulation is discussed here, other projection-based formulations can be adopted for enablement of claim 01).

03) Enable the solution of claim 01) and/or claim 02) for both structured and unstructured mesh.

04) Enable the solution of larger (by an order of magnitude) problems of the kind discussed in 01), 02) and 03) for a given computer system than what can be done using current state-of-art machine learning architectures.

5) Subtle modifications to the one-dimensional vector form mentioned in claim 01), can be made to incorporate a smaller number of elements in two or three dimensions via implementation of nearest neighbor or other metrics to enhance resolution and/or accuracy of claims 01), 02), 03), and 04) at marginally increased computation costs relative to claim 01).
